(19) United States
(12) Patent Application Publication
(10) Pub. No.: US 2026/0211535 A1
(43) Pub. Date: Jul. 23, 2026

(54) INSTANT MESSAGE PROCESSING METHOD AND APPARATUS, ELECTRONIC DEVICE, AND STORAGE MEDIUM

(71) Applicant: NETEASE (HANGZHOU) NETWORK CO., LTD., Hangzhou (CN)

(72) Inventor: Xin LI, Hangzhou (CN)

(21) Appl. No.: 19/143,216

(22) PCT Filed: Jun. 26, 2023
(86) PCT No.: PCT/CN2023/102360

§ 371 Date: Jun. 25, 2025

(30) Foreign Application Priority Data
Jan. 3, 2023 (CN) 202310004378.8

(51) Int. Cl. G06F 3/0484; G06F 3/0482

(52) U.S. Cl. CPC G06F 3/0484; G06F 3/0482

(57) ABSTRACT

The present disclosure provides a method for instant message processing, including: displaying an instant message session list corresponding to a first message group via a graphical user interface; in response to a switching operation of a message display style, determining a view display style corresponding to the first message group, where the view display style is different from a display style of the instant message session list; and displaying a message within the instant message session list via the graphical user interface based on the view display style corresponding to the first message group.

### CROSS-REFERENCE TO RELATED APPLICATIONS

The present disclosure is a 371 national phase application of PCT Application No. PCT/CN2023/102360 filed Jun. 26, 2023, which claims the priority of Chinese Patent Application No. 202310004378.8 entitled “Instant Message Processing Method, Apparatus, Electronic Device and Storage Medium” filed Jan. 3, 2023, entitled “Instant Message Processing Method, Apparatus, Electronic Device, and Storage Medium,” the entire contents of both of which applications are incorporated herein by reference.

### TECHNICAL FIELD

The present disclosure relates to communications technologies, and specifically relates to instant message processing.

### BACKGROUND

Conventionally, social software usually displays a session message to a user in the form of a session list, and only an identifier such as a session name and a session avatar is displayed in the session list. When the user processes the instant message, the user enters the session page by using a session name or a session avatar as a screening condition for message processing.

However, the display mode of the session list is too simple, and the screening condition for entering the session page is relatively limited, so that the processing efficiency of the instant message is low.

### SUMMARY

The present disclosure provides a method, system, and apparatus for instant message processing to solve the low message processing issue.

According to a first aspect, the present disclosure provides a method for instant message processing, including: displaying an instant message session list corresponding to a first message group via a graphical user interface, where the graphical user interface is provided by a terminal device; in response to a switching operation of a message display style, determining a view display style corresponding to the first message group, where the view display style is different from a display style of the instant message session list; displaying a message within the instant message session list via the graphical user interface based on the view display style corresponding to the first message group.

According to a second aspect, the present disclosure provides a system including one or more memory collectively containing one or more programs, and one or more processors, where the one or more processors are configured to, individually or collectively, perform the instant message processing method provided in the first aspect when executed.

According to a third aspect, the present disclosure provides one or more non-transitory computer-readable storage media containing, in any combination, computer program code that, when executed by a computer system, perform the instant message processing method provided in the first aspect is executed.

### BRIEF DESCRIPTION OF THE DRAWINGS

In order to more clearly illustrate the technical solutions of the embodiments of the present disclosure, the accompanying drawings required to be used in the embodiments are briefly described below, it should be understood that the following drawings show only certain embodiments of the present disclosure, and are therefore not to be considered as limiting the scope, and for those of ordinary skill in the art, other related drawings may be obtained according to these drawings without creative efforts.

FIG. 1 is a schematic flowchart of an instant message processing method according to an embodiment of the present disclosure;

FIG. 2 is a schematic diagram of a graphical user interface according to an embodiment of the present disclosure;

FIG. 3 is a schematic flowchart of an instant message processing method according to an embodiment of the present disclosure;

FIG. 4 is a schematic flowchart of an instant message processing method according to an embodiment of the present disclosure;

FIG. 5 is a schematic flowchart of an instant message processing method according to an embodiment of the present disclosure;

FIG. 6 is a schematic flowchart of an instant message processing method according to an embodiment of the present disclosure;

FIG. 7 is a schematic diagram of a graphical user interface according to an embodiment of the present disclosure;

FIG. 8 is a schematic diagram of a graphical user interface according to an embodiment of the present disclosure;

FIG. 9 is a schematic diagram of a graphical user interface according to an embodiment of the present disclosure;

FIG. 10 is a schematic flowchart of an instant message processing method according to an embodiment of the present disclosure;

FIG. 11 is a schematic diagram of a graphical user interface according to an embodiment of the present disclosure;

FIG. 12 is a schematic diagram of an instant message processing apparatus according to an embodiment of the present disclosure;

FIG. 13 is a schematic structural diagram of an electronic device according to an embodiment of the present disclosure.

### DETAILED DESCRIPTION

In order to make the objectives, technical solutions, and advantages of the embodiments of the present disclosure clearer, the technical solutions in the embodiments of the present disclosure will be clearly and completely described below with reference to the accompanying drawings in the embodiments of the present disclosure. In addition, it should be understood that the schematic drawings are not drawn to a physical scale. The flowchart used in the present disclosure illustrates operations implemented according to some embodiments of the present disclosure. It should be understood that the operations of the flowcharts may not be implemented in sequence, and steps without logical context relationships may be reversed order or implemented simultaneously. In addition, under the guidance of the present disclosure, one or more other operations may be added to the flowchart, or one or more operations may be removed from the flowchart.

In addition, the described embodiments are merely some but not all of the embodiments of the present disclosure. Components of the embodiments of the present disclosure generally described and illustrated in the drawings herein may be arranged and designed in a variety of different configurations. Therefore, the following detailed description of the embodiments of the present disclosure provided in the accompanying drawings is not intended to limit the scope of the present disclosure, but merely represents selected embodiments of the present disclosure. All other embodiments obtained by a person skilled in the art based on the embodiments of the present disclosure without creative efforts shall fall within the protection scope of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

It should be noted that the term “comprising” is used in the embodiments of the present disclosure to indicate the existence of the features declared after the term, but does not exclude adding other features.

The present disclosure provides a method, system, and apparatus for instant message processing. Through a switching operation of the message display style, a message in the first message group, displayed within an instant message session list via a graphical user interface, can be switched to be displayed based on the view display style corresponding to the first message group. Using this approach, the message display style is no longer limited to the conventional session list display style. Instead, a view display style specific to the message group can be presented the user. More specifically, different groups can have different view display styles, and therefore enable personalization of the display. As a result, the user can efficiently obtain important information within the group through the view display style and conveniently perform the next message processing operations, thereby improving the use experience. Additionally, the duration needed to adjust the view by the user is reduced, the terminal power consumption is saved, and the server load is decreased.

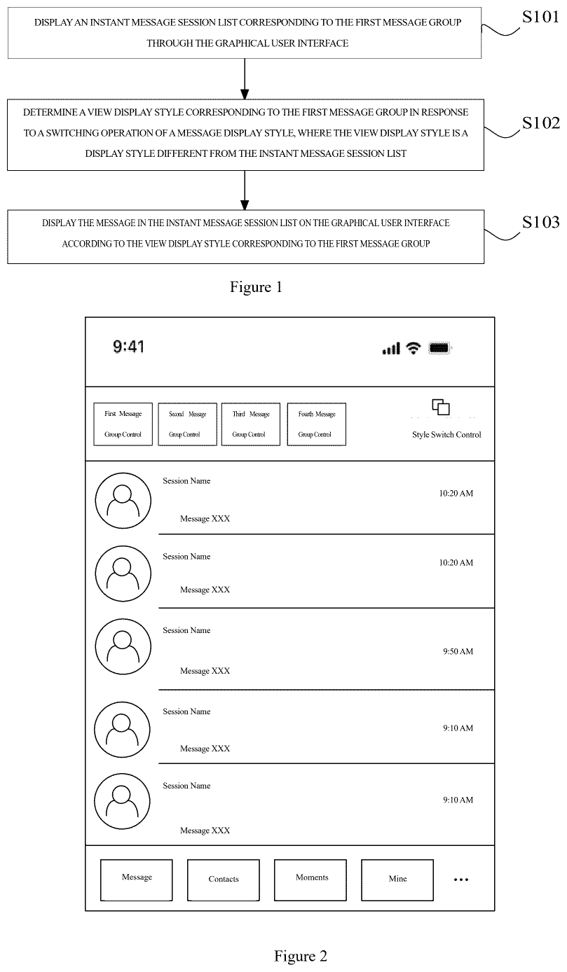

FIG. 1 is a schematic flowchart of an instant message processing method according to an embodiment of the present disclosure. FIG. 2 is a schematic diagram of a graphical user interface provided by an embodiment of the present disclosure. The execution body of the method may be a terminal device, or may be a server, and a graphical user interface may be provided by using the terminal device
S101: Display an instant message session list corresponding to a first message group through a graphical user interface.

As shown in FIG. 2, the instant message session list is also a conventional message display style when we usually use instant message software, and in this display mode of the instant message session list, each session is vertically arranged in sequence, and the user can enter a certain session interface for session reply through the session avatar and the session name.

Due to the problem of the display size of the graphical user interface, only part of the session can be displayed at the current moment, and the user can view other sessions in a manner of sliding up and down the screen.

In one embodiment, the instant message session list corresponding to the message packet may be displayed according to a specified message packet of the message. For example, when the first message packet is a time packet, all messages of the user may be sequentially arranged in a form of a session list according to a time sequence for display, where the latest session may be displayed at the uppermost party of the session list to facilitate user processing.
S102: Determine a view display style corresponding to the first message group in response to a switching operation of the message display style, where the view display style is a display style different from the instant message session list.

In some embodiments, the message display style of the instant message session list corresponding to the first message group may be switched to the view display style corresponding to the first message group based on the input message display style switching operation, the view display style is a display style different from the instant message session list. More specifically, through the switching operation, the message in the first message group displayed in the form of the instant message session list may be switched to another view display style for display.
S103: Display the message in the instant message session list on the graphical user interface according to the view display style corresponding to the first message group.

In one embodiment, based on the view display style corresponding to the first message group, the message in the instant message session list corresponding to the first message group displayed on the graphical user interface may be displayed according to the view display style.

Because the message display style of the instant message session list is relatively limited, the message can only enter the session through the session head portrait or the session name, so that the screening mode is relatively limited when the user performs message screening, the view display style displays the message in a brand-new display mode, and the view display style can more intuitively display the message to the user, so that the user processing message experience can be improved.

In conclusion, according to the instant message processing method provided in this embodiment, the message in the first message group displayed in the instant message session list on the graphical user interface can be switched to be displayed according to the view display style corresponding to the first message group through the switching operation of the message display style, so that the message display style is no longer limited to the conventional session list display style, and the view display style corresponding to the group can be provided for the user according to different message groups. More specifically, different groups can have different view display styles, so that the personalized of the display style is realized, the user can efficiently obtain important information in the group through the view display style and conveniently perform the next message processing operation, and the use experience of the user is improved; The duration of adjusting the view by the user is reduced, the electric quantity of the terminal is saved, and the running pressure of the server is reduced.

As shown in FIG. 2, the graphical user interface further includes a style switching control; in step S102, in response to a switching operation of the message display style, determining a view display style corresponding to the first message group may include: in response to a trigger operation for the style switching control, determining a view display style corresponding to the first message group.

In one embodiment, the style switching control may be disposed at any position on the graphical user interface, so as to not block other information in the interface.

In another embodiment, the switching control may also be a physical key on the terminal device, for example, a volume key, a shutdown key, a mute key, or the like. When the physical key is triggered, the trigger program of the physical key may be distinguished from a trigger program of a conventional function of the physical key, for example, a conventional volume key presses the volume change once, and when the volume key is used as the switching control, the switching of the interface may be triggered for a long press to meet the preset duration.

In another embodiment, a trigger operation or the like may be implemented by using a key on the keyboard, and the manner is not limited.

Before the style switching control is not triggered, the graphical user interface displays the instant message session list corresponding to the first message group, such as the interface currently shown in FIG. 2. After the style switching control is triggered, the view display style corresponding to the first message packet may be determined first, where the view display style corresponding to the first message packet is preset according to the feature of the packet.

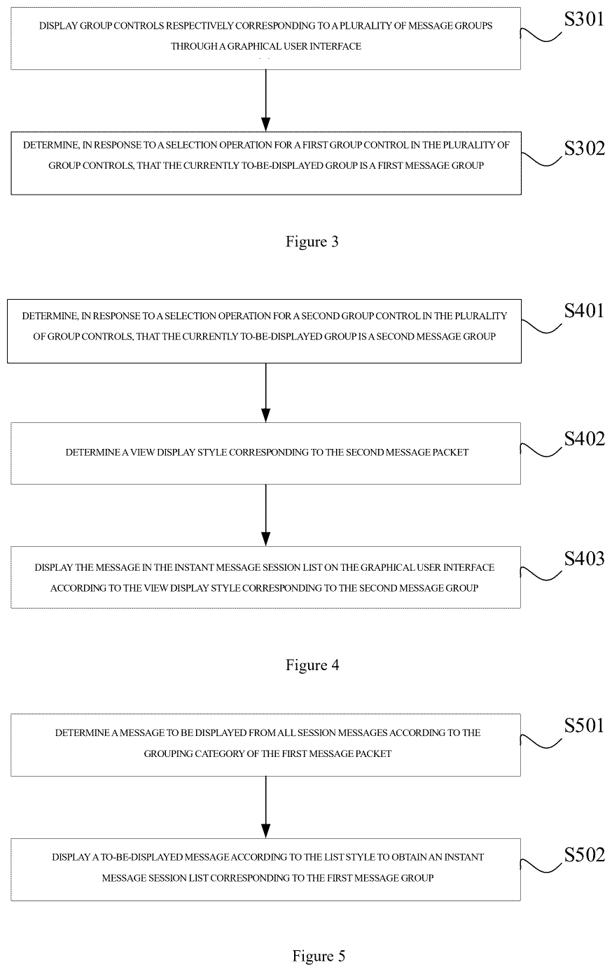

FIG. 3 is a schematic flowchart of an instant message processing method according to another embodiment of the present disclosure. In one embodiment, the method may further include the following operation.
S301: Display group controls respectively corresponding to a plurality of message groups through a graphical user interface.

As shown in FIG. 2, four group controls may be displayed at the top of the graphical user interface, the identifier of the group control may be the group name of the message group, and the user may be guided to quickly select the required group control through the group name. The group control of four message groups is exemplarily shown in FIG. 2, in practical application, more message groups can be set, and more group controls are added to the corresponding re-graphical user interface.
S302: Determine, in response to a selection operation for a first group control in the plurality of group controls, that the currently to-be-displayed group is a first message group.

In one embodiment, the current message group may be selected through the group control, and the group control may be clicked to select the group control, so that the message group corresponding to the selected group control is used as the first message group.

In the embodiment where the first message packet is determined, the message corresponding to the first message packet may be selected from all the messages, and the selected message may be displayed on the graphical user interface in the form of the instant message session list.

FIG. 4 is a schematic flowchart of an instant message processing method according to another embodiment of the present disclosure. In one embodiment, in step S103, after displaying the message in the instant message session list on the graphical user interface according to the view display style corresponding to the first message group, the method may further include the following operation.
S401: Determine, in response to a selection operation for a second group control in the plurality of group controls, that the currently to-be-displayed group is a second message group.

If the message in the instant message session list is currently displayed on the graphical user interface according to the view display style corresponding to the first message group, and the user wants to switch to another message group to display the message at this time, the group control of the second message group other than the first message group may be triggered to be selected, and the second message group may be locked as the current group to be selected. The second message packet may be any message packet other than the first message packet.

When it is determined that the currently to-be-displayed packet is the second message packet, the instant message session list corresponding to the second message packet may first be displayed on the graphical user interface.
S402: Determine a view display style corresponding to the second message packet.

After the style switching control is triggered, the view display style corresponding to the second message packet may be determined. The same view display style corresponding to the second message packet is also preset according to the grouping feature of the second message packet.
S403: Display the message in the instant message session list on the graphical user interface according to the view display style corresponding to the second message group.

In one embodiment, each message in the second message group currently displayed according to the instant message session list style in the graphical user interface may be switched to be displayed according to the view display style corresponding to the second message group.

In one embodiment, in step S103, after displaying the message in the instant message session list on the graphical user interface according to the view display style corresponding to the first message group, the method may further include: in response to a trigger operation for the style switching control, displaying the instant message session list corresponding to the first message group through the graphical user interface.

In some embodiments, when it is desired to exit from the view display style corresponding to the message packet, the style switching control may be triggered again, and the message displayed according to the view display style corresponding to the message packet may be switched back to be displayed according to the instant message session list style. When switching to the view display style again, the style switching control may be triggered again.

FIG. 5 is a schematic flowchart of an instant message processing method according to another embodiment of the present disclosure. In one embodiment, in step S101, displaying an instant message session list corresponding to a first message group through a graphical user interface may include the following operation.
S501: Determine a message to be displayed from all session messages according to the grouping category of the first message packet.

Since the user may continuously receive a new message sent by a group or a person related to the user, and there are many messages unrelated to the user for the message in the group, but also belong to the message received by the instant message account of the user, then the message amount of the user is huge, and the message packet can classify all the messages received by the user, so that partial messages can be displayed in a classified manner.

Then, after responding to the trigger operation of the packet control of the first message packet, the to-be-displayed message corresponding to the first message packet may be determined from all the session messages of the user according to the grouping category of the first message packet.
S502: Display a to-be-displayed message according to the list style to obtain an instant message session list corresponding to the first message group.

For the determined to-be-displayed message, each to-be-displayed message may be sequentially displayed in the form of the list according to the receiving time of each to-be-displayed message, to obtain the instant message session list corresponding to the first message group. The session avatar and/or session name of the message may be displayed for each message.

In one embodiment, the grouping category includes at least one of the following: a time sequence group, an unread message group, a user association message group, and a processing progress group.

The time sequence group refers to grouping the messages according to the receiving time of the message, and when displaying the instant message session list corresponding to the time sequence group, the messages may be sequentially sorted and displayed according to the latest time sequence, or the messages in the specified time may also be displayed by screening.

The unread message group refers to whether each message is grouped according to whether the message is read by the user, and the unread message group includes a message that is not read by the user.

The user association message group is a message group according to the association between the message and the user, and the user association message group includes all messages related to the user. For a single-person session, the message sent by the other party is necessarily related to the user, and for the group session, due to the fact that many members in the group can send the session message to each other, many messages irrelevant to the user will be generated, and certainly there are some messages related to the user, here referred to as “@ my” message.

The processing progress group is configured to group each message according to the processing progress of the message, for example, an unprocessed message and a processed message, and the processed message corresponds to a different processing progress.

In one embodiment, in step S501, determining the to-be-displayed message from all the session messages according to the grouping category of the first message group may include: if the grouping category of the first message group is a time sequence group, determining a specified number of latest messages from all the session messages as the to-be-displayed message.

When the first message group is a time sequence group, a specified number of latest messages in all session messages of the user may be used as messages to be displayed, where the specified number herein may be determined according to the display size of the graphical user interface and the display size of each message.

Only more recent messages may be shown within the graphical user interface display size range. The remaining messages may be displayed by scrolling up and down the user's sliding screen. When a specific display time is not specified, all messages may be sequentially arranged and displayed according to a time sequence, and the latest message is preferentially displayed, so that the user can process the latest message in time.

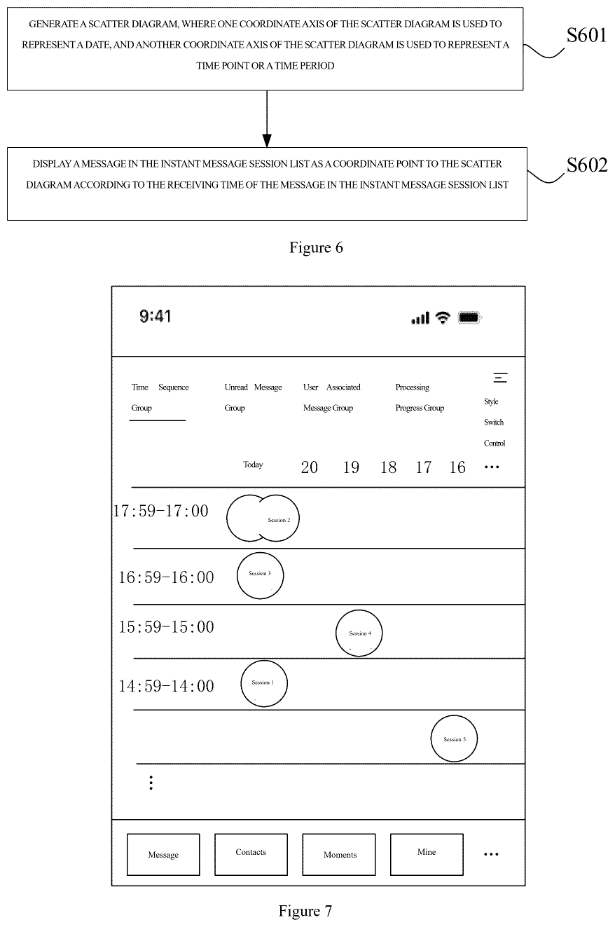

FIG. 6 is a schematic flowchart of an instant message processing method according to another embodiment of the present disclosure; and FIG. 7 is a schematic diagram of a graphical user interface according to another embodiment of the present disclosure.

If the grouping category of the first message packet is a time sequence group, in one embodiment, in step S103, displaying the message in the instant message session list on the graphical user interface according to the view display style corresponding to the first message group may include the following operation.
S601: Generate a scatter diagram, where one coordinate axis of the scatter diagram is used to represent a date, and another coordinate axis of the scatter diagram is used to represent a time point or a time period.

When the grouping category of the first message packet is a time sequence group, the view display style corresponding to the first message packet may be a scatter diagram style, as shown in FIG. 7, the scatter diagram may include a date axis and a time period axis, and certainly, in an embodiment where the screen display size is allowed, the time period may be replaced with a time point, to implement finer division of time.
S602: Display a message in the instant message session list as a coordinate point to the scatter diagram according to the receiving time of the message in the instant message session list.

According to the determined to-be-displayed message corresponding to the time sequence group, a session identifier (a session name or a session avatar) of the to-be-displayed message is displayed on the coordinate point calibrated in the corresponding date time period in the scatter diagram according to the receiving time of each to-be-displayed message, so that the user can enter the session window of the to-be-displayed message based on the session identifier.

The view display style corresponding to the time sequence group shown in FIG. 7 is specifically described. As shown in FIG. 7, each historical date before and today within a complete month may be displayed in the first operation area of the interface, for example, today 21, then each date of 21 #−1 may be displayed, respectively.

Each time period may be displayed at a preset time interval in the second operation area of the interface. More specifically, 24 hours in one day are segmented, which may be segmented uniformly according to a preset interval time, as shown in FIG. 7, segmented by using one hour as an interval time, or may be segmented according to 2 hours, 3 hours, or minutes.

In one embodiment, the first operation area may be an operation area in a horizontal direction, and in this configuration, the second operation area may be an operation area in a vertical direction, or may be exchanged, the first operation area may be an operation area in a vertical direction, and in this configuration, the second operation area is an operation area in a horizontal direction.

Similarly, for each time period in the second operation area, in one embodiment, the target time period may be selected by sliding in a vertical direction.

In one embodiment, the receiving time of the message to be displayed may be used as the target display date and the target display time of each message.

For example, when the receiving time of the message 1 is 14:30 today, it may be determined that the target display date of the message 1 is today, and the target display time is 14:30.

In one embodiment, as shown in FIG. 7, the session identifier of the message 1 may be displayed on the coordinate point corresponding to the time period of the second operation area 14:59-14:00 in today of the first operation area, where only the session avatar of the message 1 may be displayed, or only the session name of the message 1 may be displayed, or the avatar and the name of the session 1 may be displayed at the same time.

In some embodiments, if there are a plurality of to-be-displayed messages at the same time at the same time, the session identifiers of the plurality of messages may be superimposed and displayed on the coordinate points corresponding to the time period under the date. In addition, there may be overlapping but incomplete shielding with each other when displayed in a superimposed manner.

Based on the foregoing manner, each to-be-displayed message corresponding to the time sequence group may be displayed in a corresponding date and time period, and the user may select the target date and the target time period based on a trigger operation on a date in the first operation area and a time period in the second operation area, so as to quickly select a session of the concerned date and time period from a large number of messages.

In one embodiment, in response to a trigger operation on the target date and the session identifier of the target message displayed on the coordinate point of the target time period, the session may enter the session to quickly process the target message in the session.

In one embodiment, in this view display style corresponding to the time sequence group, a screening condition of year and month may also be set, which is not limited to the screening of the dates and time periods listed in this embodiment, so that more refined screening can be performed.

In one embodiment, in step S501, determining the message to be displayed from all the session messages according to the grouping category of the first message group may include: if the grouping category of the first message group is an unread message group, determining that the message that is not read by the user is the message to be displayed from all the session messages.

When the first message packet is an unread message group, the message that is not read by all the users may be determined as the to-be-displayed message from all the session messages of the user.

In one embodiment, if the grouping category of the first message packet is an unread message group, in step S103, displaying the message in the instant message session list on the graphical user interface according to the view display style corresponding to the first message group may include: sequentially displaying each unread message entry on the graphical user interface according to the receiving time of the unread message, where each unread message entry includes an unread message and auxiliary information, and the unread message is highlighted in the corresponding unread message entry relative to the auxiliary information.

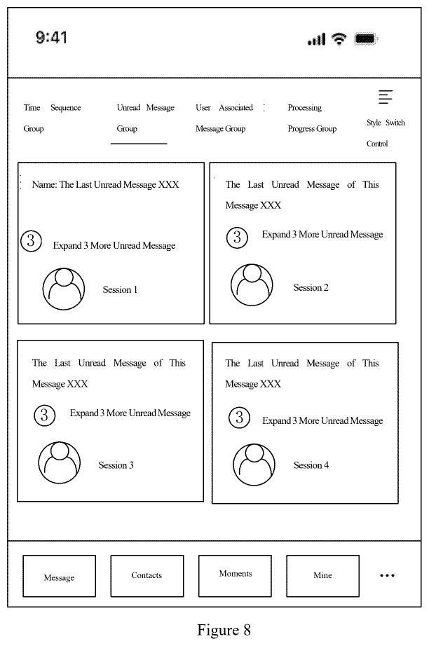

FIG. 8 is a schematic diagram of a graphical user interface according to another embodiment of the present disclosure. In a view display style corresponding to an unread message group, a message that is not read by a user may be displayed in a graphical user interface, so as to focus on separate display of the unread message, which is convenient for the user to quickly process the unread message.

The unread message also refers to that after the user receives the message, the user does not enter the session window to read the message, and the message is always in the unread state, and usually the new message received from the latest session window of the user to the current moment belongs to the unread message.

In some office instant chat software, whether the message is read by the user will generate a corresponding mark, the read mark is displayed below the read message, the unread mark is displayed below the unread message, and for the chat software, the unread message in the session can be obtained through the mark information below the message.

As shown in FIG. 8, four unread messages are exemplarily shown, where four messages may respectively come from different session windows. In some embodiments, the display order of each unread message may be sorted according to the receiving time of each unread message, the closer the receiving time of the unread message to the current moment, the higher the priority of the unread message may be considered, and then the arrangement thereof may be more forward.

For example, the receiving moment of the unread message 1 is 12:00, the receiving moment of the unread message 2 is 13:00, the receiving moment of the unread message 3 is 13:30, and the current moment is 15:00, then the unread message 1 can be arranged at the position on the left side of the first row in FIG. 8, the unread message 2 is arranged at the position on the right side of the first row, and the unread message 3 is arranged at the position on the left side of the second row. This arrangement is based on one embodiment on the basis that each row can only layout two unread messages, and the number of sessions that can be arranged in each row in the actual application is not fixed.

Since the receiving time of the unread message is farther away from the current moment, the earlier the receiving time of the unread message is, in order to facilitate rapid processing of the unread message with long backlog, the farther the receiving time of the unread new message from the current moment, the higher the priority of the unread message is, the higher the priority of the unread message can be arranged. More specifically, the sorting is opposite to the forward sorting manner described above.

In one embodiment, when the unread message in one session window includes only one message, the unread message may be separately displayed. As shown in FIG. 8, the latest unread message (the last unread message) in the session window may be displayed in the first manner, and the first manner herein may be an enlarged display, a highlight display, etc. so that the latest unread message in the session can be quickly read.

For other unread messages other than the latest unread message, as shown in FIG. 8, the compressed display may be displayed below the latest unread message, and the second manner herein is to distinguish from the first manner, and the second manner may be a zoom-out display, a non-highlight display, or the like, or in order to highlight the display of the latest unread message.

By clicking on other unread messages displayed by compression, each unread message may be sequentially displayed in sequence according to the receiving time of each unread message.

In one embodiment, in response to a trigger operation on each unread message, complete content of the unread message may be triggered to be displayed, so that the unread message may be quickly read without entering the session window.

In one embodiment, in step S501, determining the message to be displayed from all the session messages according to the grouping category of the first message group may include: if the grouping category of the first message group is the user association message group, determining, from all the session messages, that the message referring to the user is the message to be displayed.

When the first message packet is the user-associated message group, the user-mentioned message in all the messages received by the user may be determined as the to-be-displayed message. More specifically, the “@ my” message is determined as the message to be displayed.

In one embodiment, if the grouping category of the first message packet is the user association message group, in step S103, displaying the message in the instant message session list on the graphical user interface according to the view display style corresponding to the first message group may include: displaying each user association message entry on the graphical user interface, where each user association message entry includes a message and a reply control that refer to the user, and the reply control is configured to receive the input content of the user.

In one embodiment, there are more messages in a group session, and in order to facilitate a user to quickly process a message related to the user, a message related to the user may be obtained from each session. More specifically, a message of “@ my” is obtained.

In some embodiments, for each session window, only the latest message related to the user in each session window may be extracted and displayed, and then the display priority of each message related to the user may be determined according to the latest receiving time of the message related to the user in each session window.

In some other embodiments, each message related to the user in each session window may be extracted and displayed, and then for each message related to the user in one session window, the display priorities of the messages related to the user in one session window may be sorted according to the receiving time of each message related to the user.

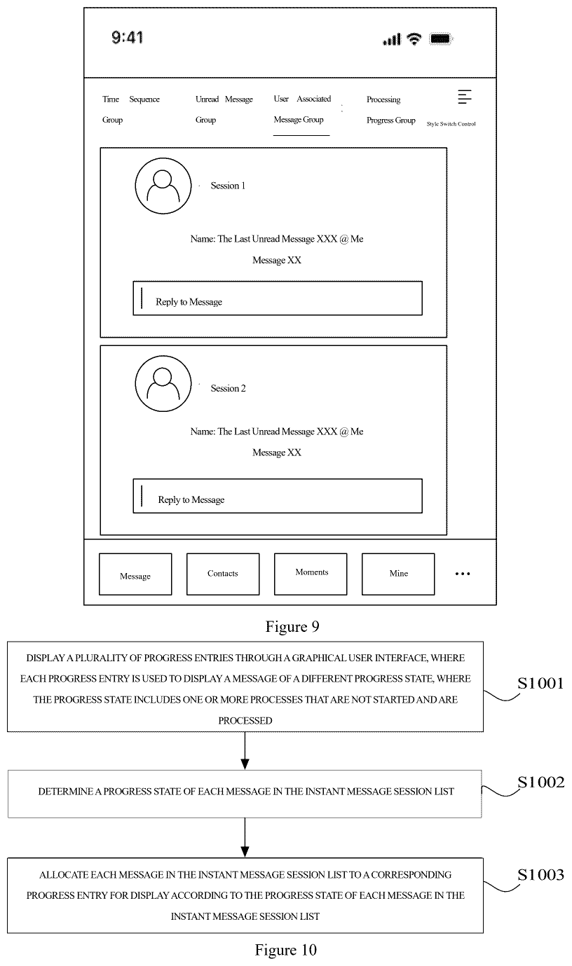

FIG. 9 is a schematic diagram of a graphical user interface according to another embodiment of the present disclosure. As shown in FIG. 9, taking only the instant messages in the two session windows in the interface as an example, the two session windows may respectively correspond to a message display area, and messages related to the user in each session window are displayed in the message display area corresponding to each session window.

In FIG. 9, only one message related to the user is displayed in the message display area of each session window by taking only the latest message related to the user in each session window as an example. The arrangement order of each session window is determined by the latest receiving time of the latest message related to the user in each session window, and it is assumed that the latest receiving time of the message related to the user in the session window 1 is 14:00. The latest receipt time of the message associated with the user in the session window 2 is 14:30: The current time is 15:00, since the latest receiving time of the latest message related to the user in the session window 2 is closer to the current time, it may be considered that the priority thereof is higher, then the latest message related to the user in the session window 2 may be displayed in the first row above, the session window 2 is displayed in the second row, and so on, and the latest one of the session windows is sequentially arranged with the user-related message.

When a plurality of messages related to the user in each session window need to be displayed, the size of the message display area corresponding to each session window may be adaptively expanded, or the number of message display areas corresponding to each session window may also be increased.

For this manner of increasing the number of message display areas corresponding to each session window, it may be understood that the two session windows shown in FIG. 9 are the same session window, a message related to the user in the session window 1 is displayed in the previous message display area, another message related to the user in the session window 1 is displayed in the next message display area, and when there are more messages related to the user in the session window 1, the corresponding number of message display areas may continue to be increased.

As shown in FIG. 9, a message reply area may also be displayed in the message display area corresponding to the session window, and the message reply area is used to conveniently reply the displayed unread message related to the user. The reply control is configured to, in response to the input content of the user, send the input content to the session window corresponding to the message referring to the user.

In one embodiment, in order to avoid the disorder of the reply of each message, the corresponding message reply area may be displayed below each unread message related to the user, and the user may input the reply content of the message related to the user through the message reply control in the message reply area, so as to quickly reply to the message related to the user, without entering the session window for reply.

In one embodiment, for a session window, each message related to the user in one session window may be jointly provided with a message reply control, and when any message related to the user needs to be replied to, the message related to the user to be replied may be selected first, and then the message content to be replied is input in the message reply area through the message reply control.

In one embodiment, in step S501, determining the to-be-displayed message from all the session messages according to the grouping category of the first message group may include: if the grouping category of the first message group is the processing progress group, determining that the specified number of latest messages are to-be-displayed messages from all the session messages.

When the first message packet is the processing progress group, the specified number of latest messages may be determined from all the session messages of the user as the to-be-displayed message, and the specified number herein May also be determined according to the display size of the graphical user interface and the size of the message. The determined to-be-displayed message may include messages of various processing progress.

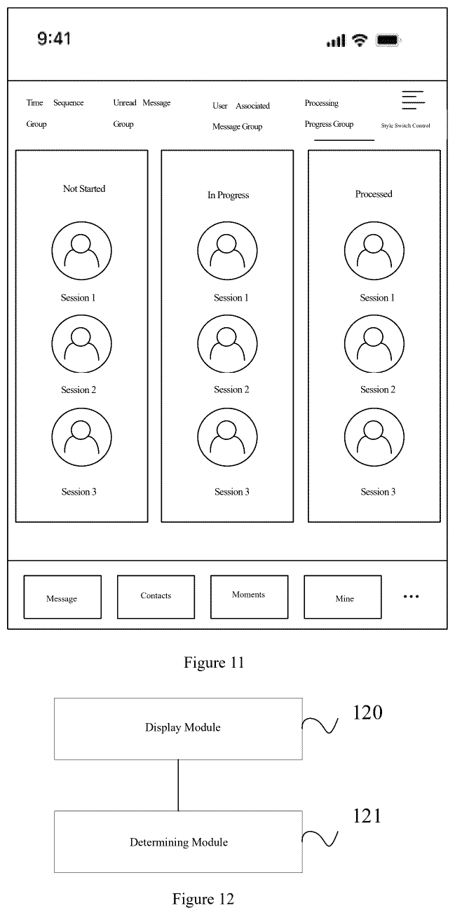

FIG. 10 is a schematic flowchart of an instant message processing method according to another embodiment of the present disclosure; if the grouping category of the first message group is a processing progress group, in step S103, displaying the message in the instant message session list on the graphical user interface according to the view display style corresponding to the first message group may include the following operation.
S1001: Display a plurality of progress entries through a graphical user interface, where each progress entry is used to display a message of a different progress state, where the progress state includes one or more processes that are not started and are processed.

FIG. 11 is a schematic diagram of a graphical user interface according to another embodiment of the present disclosure. As shown in FIG. 11, the view display style corresponding to the processing progress group may include a plurality of progress entries, and in this embodiment, the processing progress may be divided into three progress items that are not started, neutralized, and processed, and then three progress entries that are not started, executed, and processed may be separately displayed on the corresponding graphical user interface.

By distinguishing and displaying the message according to the message processing progress, it is convenient for the user to selectively process the message according to the processing requirement of the message.
S1002: Determine a progress state of each message in the instant message session list.

In one embodiment, each message in the instant message session list may correspond to a message processing flag, and the message processing flag may be used to indicate a processing progress of the message. The message processing mark may be generated by the user in advance of marking the message. A message processing flag of the target session may be generated in response to a marking operation of the user in the target session in the session list.

The marking manner may be clicking the message, changing the mark in the pop-up mark changing box, or may be a horizontal sliding operation in the conversation window where the message is located, triggering the pop-up mark changing option, and selecting the mark in the mark changing option.

After receiving the new message, if the user immediately processes the message, the message may be marked as processed, and if the user does not process currently after receiving the new message, the message may be marked as not started, and if the user is processing the received new message, but there are more urgent new messages to be processed in the processing process, the message being processed may be marked as in progress.

Based on the marks made by the user on the messages, the message processing mark of each message can be generated, and the processing progress state of the message can be obtained according to the message processing mark of the message.
S1003: Allocate each message in the instant message session list to a corresponding progress entry for display according to the progress state of each message in the instant message session list.

In one embodiment, as shown in FIG. 11, based on the obtained processing progress state of each message, the session identifier of each message may be displayed in the message display area corresponding to each progress entry. More specifically, the session identifier of each message is displayed under the corresponding progress entry, so that the user may select the message from the corresponding progress entry for processing according to the message processing progress requirement.

For example, if the user wants to process the unstarted message, the user may enter the session window by clicking the session identifier of the to-be-processed message in the message display area corresponding to the unstarted progress entry, so as to perform message processing.

In some embodiments, the message processing flag of each message may also be automatically generated, and the terminal device may generate a message processing flag for each message according to a processing operation of the user on the message.

In addition, each message displayed in each progress entry may also be adjusted, for example, the message 1 in the progress entry is not started, and after the user completes processing of the message 1, the message processing mark of the message 1 may be changed from not started to being processed, and in this configuration, the message 1 may be adjusted from the unstarted progress entry to the processed progress entry.

The message of the user is displayed through the view display style of the four message groups provided by the method, and the message of the user can be displayed with different dimensions according to the grouping characteristics of the message groups, so that diversified message screening modes can be provided for the user, and the message processing experience of the user is improved.

In conclusion, according to the instant message processing method provided in this embodiment, the message in the first message group displayed in the instant message session list on the graphical user interface can be switched to be displayed according to the view display style corresponding to the first message group through the switching operation of the message display style, so that the message display style is no longer limited to the conventional session list display style, the view display style corresponding to the group can be provided for the user. More specifically, different groups can have different view display styles, so that the personalized of the display style is realized, the user can efficiently obtain important information in the group through the view display style and conveniently perform the next message processing operation, and the use experience of the user is improved; The duration of adjusting the view by the user is reduced, the electric quantity of the terminal is saved, and the running pressure of the server is reduced.

The following describes an apparatus, a device, a storage medium, and the like for executing the instant message processing method provided in the present disclosure, and the specific implementation process and technical effects thereof are described above, and details are not described herein again.

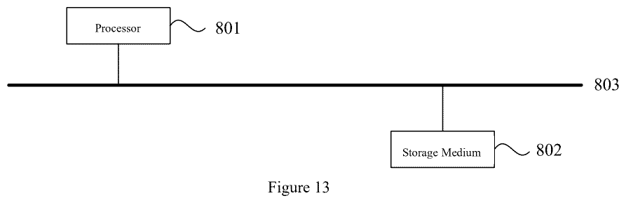

FIG. 12 is a schematic diagram of an instant message processing apparatus according to an embodiment of the present disclosure, and functions implemented by the instant message processing apparatus correspond to steps performed by the foregoing method. The apparatus may be understood as the foregoing terminal device or server, or a processor of a server, or may be understood as a component that implements the function of the present disclosure under control of a server independent of the server or the processor, and an instant message session list is displayed on a session list interface of the terminal device, as shown in FIG. 12, the apparatus may include: a display module 120 and a determining module 121; a display module 120, configured to display an instant message session list corresponding to the first message group through a graphical user interface; a determining module 121, configured to determine a view display style corresponding to the first message group in response to a switching operation of the message display style, where the view display style is a display style different from the instant message session list; the display module 120 is configured to execute the message in the instant message session list on the graphical user interface according to the view display style corresponding to the first message group.

In one embodiment, the graphical user interface further includes a style switching control, and the determining module 121 is specifically configured to determine a view display style corresponding to the first message packet in response to a trigger operation for the style switching control.

In one embodiment, the display module 120 is further configured to display group controls respectively corresponding to the plurality of message groups through the graphical user interface; and the determining module 121 is further configured to determine that the currently to-be-displayed packet is the first message packet in response to a selection operation for the first group control in the plurality of group controls.

The display module 120 is specifically configured to determine, in response to a selection operation for a second group control among the plurality of group controls, that the currently to-be-displayed group is a second message group; determining a view display style corresponding to the second message packet; and presenting the message in the instant message session list on the graphical user interface according to the view display style corresponding to the second message group.

The display module 120 is specifically configured to display the instant message session list corresponding to the first message group through the graphical user interface in response to a trigger operation for the style switching control.

The display module 120 is specifically configured to determine a to-be-displayed message from all session messages according to the grouping category of the first message packet; and displaying the message to be displayed according to the list style to obtain the instant message session list corresponding to the first message group.

In one embodiment, the grouping category includes at least one of the following: a time sequence group, an unread message group, a user association message group, and a processing progress group.

The determining module 121 is specifically configured to determine, if the grouping category of the first message packet is a time sequence group, a specified number of latest messages from all the session messages as the to-be-displayed message.

In one embodiment, if the grouping category of the first message packet is a time sequence group, the display module 120 is specifically configured to generate a scatter diagram, where a coordinate axis of the scatter diagram is used to represent a date, another coordinate axis of the scatter diagram is used to represent a time point or a time period, and the message in the instant message session list is displayed as the coordinate point to the scatter diagram according to the receiving time of the message in the instant message session list.

In one embodiment, the determining module 121 is specifically configured to: if the grouping category of the first message packet is an unread message group, determine, from all the session messages, that the message that is not read by the user is the message to be displayed.

In one embodiment, if the grouping category of the first message packet is an unread message group, the display module 120 is specifically configured to sequentially display each unread message entry on a graphical user interface according to a receiving time of an unread message, where each unread message entry includes an unread message and auxiliary information, and the unread message is highlighted in a corresponding unread message entry relative to the auxiliary information.

In one embodiment, the determining module 121 is specifically configured to: if the grouping category of the first message packet is the user association message group, determine, from all the session messages, that the message referring to the user is the message to be displayed.

In one embodiment, if the grouping category of the first message packet is a user association message group, the display module 120 is specifically configured to display each user-associated message entry on a graphical user interface, where each user-associated message entry includes a user-mentioned message and a reply control, and the reply control is configured to receive input content of the user.

In one embodiment, the determining module 121 is specifically configured to determine that the specified number of latest messages are to-be-displayed messages from all the session messages if the grouping category of the first message group is the processing progress group.

In one embodiment, if the grouping category of the first message packet is a processing progress group, the display module 120 is specifically configured to: display a plurality of progress entries through a graphical user interface, where each progress entry is used to display messages of different progress states, and the progress state includes an unstarted state and a medium state; determine a progress state of each message in the instant message session list, where each message in the instant message session list is allocated to the corresponding progress entry for display according to the progress state of each message in the instant message session list.

Through the above device, the display module can switch the message in the first message group displayed in the instant message session list on the graphical user interface into the view display style corresponding to the first message group through the switching operation of the message display style, so that the message display style is no longer limited to the conventional session list display style, the view display style corresponding to the group can be provided for the user. More specifically, different groups can have different view display styles, so that the personalized of the display style is realized, the user can efficiently obtain important information in the group through the view display style and conveniently perform the next message processing operation, and the use experience of the user is improved; The duration of adjusting the view by the user is reduced, the electric quantity of the terminal is saved, and the running pressure of the server is reduced.

The foregoing modules may be one or more integrated circuits configured to implement the foregoing methods, for example, one or more Application Specific Integrated Circuit (ASIC), or one or more microprocessors (DSPs), or one or more Field Programmable Gate Arrays (FPGAs). For another example, when the foregoing module is implemented in a form of scheduling program code by using a processing element, the processing element may be a general-purpose processor, for example, a central processing unit (CPU) or another processor that can invoke the program code. For another example, these modules may be integrated together and implemented in a form of a system-on-a-chip (SOC).

The modules may be connected or communicated with each other via a wired connection or a wireless connection. The wired connection may include a metal cable, an optical cable, a hybrid cable, or the like, or any combination thereof. The wireless connection may include a connection in the form of a LAN, WAN, Bluetooth, Igeiger EE, or NFC, or any combination thereof. Two or more modules may be combined into a single module, and any one module may be divided into two or more units. It may be clearly understood by a person skilled in the art that, for the purpose of convenient and brief description, for a detailed working process of the foregoing system and apparatus, refer to a corresponding process in the method embodiments, and details are not described herein again.

FIG. 13 is a schematic structural diagram of an electronic device according to an embodiment of the present disclosure, including a processor 801, a storage medium 802, and a bus 803. The storage medium 802 stores machine-readable instructions executable by the processor 801. When the electronic device runs, the processor communicates with the storage medium through a bus, and the processor executes the program instructions to perform operations, including: displaying an instant message session list corresponding to the first message group through a graphical user interface; determining a view display style corresponding to the first message group in response to a switching operation of the message display style, where the view display style is a display style different from the instant message session list; and presenting the message in the instant message session list on the graphical user interface according to the view display style corresponding to the first message group.

In one embodiment, the graphical user interface further includes a style switching control, and when executing the switching operation in response to the message display style, the processor 801 is specifically configured to, in response to a trigger operation for the style switching control, determine a view display style corresponding to the first message group.

In one embodiment, the processor 801 is further configured to: display, by using a graphical user interface, group controls respectively corresponding to the plurality of message groups; and in response to a selection operation for the first group control in the plurality of group controls, determining that the currently to-be-displayed group is the first message group.

In one embodiment, after displaying the message in the instant message session list on the graphical user interface according to the view display style corresponding to the first message group, the processor 801 is further configured to: in response to a selection operation for the second group control in the plurality of group controls, determine that the currently to-be-displayed group is the second message group; determining a view display style corresponding to the second message packet; and presenting the message in the instant message session list on the graphical user interface according to the view display style corresponding to the second message group.

In one embodiment, after displaying the message in the instant message session list on the graphical user interface according to the view display style corresponding to the first message group, the processor 801 is further configured to: in response to a trigger operation for the style switching control, display the instant message session list corresponding to the first message group through the graphical user interface.

In one embodiment, when the processor 801 performs displaying the instant message session list corresponding to the first message group through the graphical user interface, the processor 801 is specifically configured to: determine a to-be-displayed message from all the session messages according to the grouping category of the first message group; and display the message to be displayed according to the list style to obtain the instant message session list corresponding to the first message group.

In one embodiment, the grouping category includes at least one of the following: a time sequence group, an unread message group, a user association message group, and a processing progress group.

In one embodiment, when determining the to-be-displayed message from all the session messages based on the grouping category of the first message packet, the processor 801 is specifically configured to, if the grouping category of the first message packet is a time sequence group, determine a specified number of latest messages from all the session messages as the to-be-displayed message.

In one embodiment, if the grouping category of the first message group is a time sequence group, when executing the message in the instant message session list on the graphical user interface according to the view display style corresponding to the first message group, the processor 801 is specifically configured to generate a scatter diagram, where one coordinate axis of the scatter diagram is used to represent a date, and the other coordinate axis of the scatter diagram is used to represent a time point or a time period; the message in the instant message session list is displayed as the coordinate point to the scatter diagram according to the receiving time of the message in the instant message session list.

In one embodiment, when determining the to-be-displayed message from all the session messages according to the grouping category of the first message packet, the processor 801 is specifically configured to, if the grouping category of the first message packet is an unread message group, determine that the message that is not read by the user is the to-be-displayed message from all the session messages.

In one embodiment, if the group category of the first message group is an unread message group, the processor 801 is specifically configured to, when executing the message in the instant message session list on the graphical user interface according to the view display style corresponding to the first message group, sequentially display each unread message entry on the graphical user interface according to the receiving time of the unread message, where each unread message entry includes an unread message and auxiliary information, and the unread message is highlighted in the corresponding unread message entry relative to the auxiliary information.

In one embodiment, when determining the to-be-displayed message from all the session messages according to the grouping category of the first message packet, the processor 801 is specifically configured to, if the grouping category of the first message group is the user association message group, determine, from all the session messages, that the message referring to the user is the to-be-displayed message.

In one embodiment, if the grouping category of the first message group is the user association message group, when executing the message in the instant message session list on the graphical user interface according to the view display style corresponding to the first message group, the processor 801 is specifically configured to display each user association message entry on the graphical user interface, where each user association message entry includes a message and a reply control that refer to the user, and the reply control is configured to receive the input content of the user.

In one embodiment, when determining the to-be-displayed message from all the session messages according to the grouping category of the first message packet, the processor 801 is specifically configured to, if the grouping category of the first message group is the processing progress group, determine that the specified number of latest messages are to-be-displayed messages from all the session messages.

In one embodiment, if the grouping category of the first message group is the processing progress group, when executing the message in the instant message session list on the graphical user interface according to the view display style corresponding to the first message group, the processor 801 is specifically configured to display a plurality of progress entries through the graphical user interface, where each progress entry is used to display messages of different progress states, where the progress state includes an unstarted, in-progress, and processed; determine a progress state of each message in the instant message session list, where each message in the instant message session list is allocated to the corresponding progress entry for display according to the progress state of each message in the instant message session list.

Through the disclosed approach, when the terminal device performs the switching operation of the message display style, the message in the first message group displayed in the instant message session list on the graphical user interface can be switched to be displayed according to the view display style corresponding to the first message group, so that the message display style is no longer limited to the conventional session list display style, and the view display style corresponding to the group can be provided for the user. More specifically, different groups can have different view display styles, so that the personalized of the display style is realized, the user can efficiently obtain important information in the group through the view display style and conveniently perform the next message processing operation, and the use experience of the user is improved; The duration of adjusting the view by the user is reduced, the electric quantity of the terminal is saved, and the running pressure of the server is reduced.

The storage medium 802 stores program code, and when the program code is executed by the processor 801, the processor 801 executes various steps in the instant message processing method according to various exemplary embodiments of the present disclosure described in the “exemplary method” part of the present specification.

The processor 801 may be a general-purpose processor, such as a central processing unit (CPU), a Digital Signal Processor (DSP), an Application Specific Integrated Circuit (ASIC), a Field Programmable Gate Array (FPGA), or other programmable logic devices, discrete gates or transistor logic devices, and discrete hardware components, which may implement or perform the methods, steps, and logical block diagrams disclosed in the embodiments of the present disclosure. The general-purpose processor may be a microprocessor, any conventional processor, or the like. The steps of the methods disclosed with reference to the embodiments of the present disclosure may be directly performed and completed by a hardware processor, or may be performed and completed by using a combination of hardware and software modules in the processor.

The storage medium 802 is a non-volatile computer-readable storage medium, and may be configured to store a non-volatile software program, a non-volatile computer-executable program, and a module. The memory may include at least one type of storage medium, for example, may include a flash memory, a hard disk, a multimedia card, a card type memory, a Random Access Memory (RAM), a Static Random Access Memory (SRAM), a Programmable Read Only Memory (PROM), a Read Only Memory (ROM), an Electrically Erasable Programmable Read-Only Memory (EEPROM), a magnetic memory, a magnetic disk, an optical disk, and the like. The memory is any other medium that can be used to carry or store desired program code in the form of instructions or data structures and that can be accessed by a computer, but is not limited thereto. The storage medium 802 in the embodiments of the present disclosure may also be a circuit or any other apparatus that can implement a storage function, and is configured to store program instructions and/or data.

In one embodiment, an embodiment of the present disclosure further provides a computer-readable storage medium, where the computer-readable storage medium stores a computer program, the computer program is executed when the computer program is run by the processor, and the processor executes the following steps: displaying an instant message session list corresponding to the first message group through a graphical user interface; determining a view display style corresponding to the first message group in response to a switching operation of the message display style, where the view display style is a display style different from the instant message session list; and presenting the message in the instant message session list on the graphical user interface according to the view display style corresponding to the first message group.

In one embodiment, the graphical user interface further includes a style switching control, and when executing the switching operation in response to the message display style, the processor 801 is specifically configured to, in response to a trigger operation for the style switching control, determine a view display style corresponding to the first message group.

In one embodiment, the processor 801 is further configured to: display, by using a graphical user interface, group controls respectively corresponding to the plurality of message groups; and, in response to a selection operation for the first group control in the plurality of group controls, determine that the currently to-be-displayed group is the first message group.

In one embodiment, after displaying the message in the instant message session list on the graphical user interface according to the view display style corresponding to the first message group, the processor 801 is further configured to: in response to a selection operation for the second group control in the plurality of group controls, determine that the currently to-be-displayed group is the second message group; determine a view display style corresponding to the second message packet; and present the message in the instant message session list on the graphical user interface according to the view display style corresponding to the second message group.

In one embodiment, after displaying the message in the instant message session list on the graphical user interface according to the view display style corresponding to the first message group, the processor 801 is further configured to: in response to a trigger operation for the style switching control, display the instant message session list corresponding to the first message group through the graphical user interface.

In one embodiment, when the processor 801 performs displaying the instant message session list corresponding to the first message group through the graphical user interface, the processor 801 is specifically configured to: determine a to-be-displayed message from all the session messages according to the grouping category of the first message group; and display the message to be displayed according to the list style to obtain the instant message session list corresponding to the first message group.

In one embodiment, the grouping category includes at least one of the following: a time sequence group, an unread message group, a user association message group, and a processing progress group.

In one embodiment, when determining the to-be-displayed message from all the session messages based on the grouping category of the first message packet, the processor 801 is specifically configured to, if the grouping category of the first message packet is a time sequence group, determine a specified number of latest messages from all the session messages as the to-be-displayed message.

In one embodiment, if the grouping category of the first message group is a time sequence group, when executing the message in the instant message session list on the graphical user interface according to the view display style corresponding to the first message group, the processor 801 is specifically configured to generate a scatter diagram, where one coordinate axis of the scatter diagram is used to represent a date, the other coordinate axis of the scatter diagram is used to represent a time point or a time period, and the message in the instant message session list is displayed as the coordinate point to the scatter diagram according to the receiving time of the message in the instant message session list.

In one embodiment, when determining the to-be-displayed message from all the session messages according to the grouping category of the first message packet, the processor 801 is specifically configured to, if the grouping category of the first message packet is an unread message group, determine that the message that is not read by the user is the to-be-displayed message from all the session messages.

In one embodiment, if the group category of the first message group is an unread message group, the processor 801 is specifically configured to, when executing the message in the instant message session list on the graphical user interface according to the view display style corresponding to the first message group, sequentially display each unread message entry on the graphical user interface according to the receiving time of the unread message, where each unread message entry includes an unread message and auxiliary information, and the unread message is highlighted in the corresponding unread message entry relative to the auxiliary information.

In one embodiment, when determining the to-be-displayed message from all the session messages according to the grouping category of the first message packet, the processor 801 is specifically configured to, if the grouping category of the first message group is the user association message group, determine, from all the session messages, that the message referring to the user is the to-be-displayed message.

In one embodiment, if the grouping category of the first message group is the user association message group, when executing the message in the instant message session list on the graphical user interface according to the view display style corresponding to the first message group, the processor 801 is specifically configured to display each user association message entry on the graphical user interface, where each user association message entry includes a message and a reply control that refer to the user, and the reply control is configured to receive the input content of the user.

In one embodiment, when determining the to-be-displayed message from all the session messages according to the grouping category of the first message packet, the processor 801 is specifically configured to, if the grouping category of the first message group is the processing progress group, determine that the specified number of latest messages are to-be-displayed messages from all the session messages.

In one embodiment, if the grouping category of the first message group is the processing progress group, when executing the message in the instant message session list on the graphical user interface according to the view display style corresponding to the first message group, the processor 801 is specifically configured to display a plurality of progress entries through the graphical user interface, where each progress entry is used to display messages of different progress states, where the progress state includes an unstarted, in-progress, and processed; determine a progress state of each message in the instant message session list, where each message in the instant message session list is allocated to the corresponding progress entry for display according to the progress state of each message in the instant message session list.

Through the disclosed approach, when the terminal device performs the switching operation through the message display style, the message in the first message group displayed in the instant message session list on the graphical user interface can be switched to be displayed according to the view display style corresponding to the first message group, so that the message display style is no longer limited to the conventional session list display style, the user is not limited to screening the incoming message session through each session head portrait or session name in the session list, and the user can enter the message session or perform message processing in other message screening modes provided in the view display style, thereby improving the experience degree and the visual experience of the message processing of the user.

In the embodiments of the present disclosure, when the computer program is run by the processor, other machine-readable instructions may also be executed to perform the methods described in the other embodiments, for specific execution method steps and principles, reference may be made to the description of the embodiments, and details are not described herein again.

In the several embodiments provided in the present disclosure, it should be understood that the disclosed apparatus and method may be implemented in other manners. For example, the apparatus embodiments described above are merely illustrative, for example, the division of the units is merely a logical function division, and there may be other division manners in actual implementation, for example, a plurality of units or components may be combined or may be integrated into another system, or some features may be ignored or not performed. In addition, the displayed or discussed mutual coupling or direct coupling or communication connection may be indirect coupling or communication connection through some interfaces, devices or units, and may be in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a hardware plus software functional unit.

The integrated unit implemented in the form of a software functional unit may be stored in a computer-readable storage medium. The software functional unit is stored in a storage medium, and includes several instructions to enable a computer device (which may be a personal computer, a server, or a network device) or a processor to perform some steps of the method in the embodiments of the present disclosure. The foregoing storage medium includes any medium that can store program code, such as a USB flash drive, a removable hard disk, a read-only memory (ROM), a random access memory (RAM), a magnetic disk, or an optical disk.

1. A method for instant message processing, comprising:
displaying an instant message session list corresponding to a first message group via a graphical user interface, wherein the graphical user interface is provided by a terminal device;
in response to a switching operation of a message display style, determining a view display style corresponding to the first message group, wherein the view display style is different from a display style of the instant message session list; and
displaying a message within the instant message session list via the graphical user interface based on the view display style corresponding to the first message group.

2. The method according to claim 1, wherein the graphical user interface comprises a style switching control element, and
determining the view display style corresponding to the first message group in response to the switching operation of the message display style comprises:
in response to a trigger operation on the style switching control element, determining the view display style corresponding to the first message group.

3. The method according to claim 1, further comprising:
displaying a plurality of group controls respectively corresponding to a plurality of message groups via the graphical user interface; and
in response to a selection operation on a first group control among the plurality of group controls, determining that a currently to-be-displayed group is the first message group.

4. The method according to claim 3, wherein, after displaying the message in within the instant message session list via the graphical user interface based on the view display style corresponding to the first message group, the method further comprises:
in response to a selection operation on a second group control among the plurality of group controls, determining that the currently to-be-displayed group is a second message group;
determining a view display style corresponding to the second message group; and
displaying the message within the instant message session list via the graphical user interface based on the view display style corresponding to the second message group.

5. The method according to claim 2, wherein, after displaying the message within the instant message session list via the graphical user interface based on the view display style corresponding to the first message group, the method further comprises:
displaying, in response to a trigger operation for the style switching control element, the instant message session list corresponding to the first message group via the graphical user interface.

6. The method according to claim 1, wherein displaying the instant message session list corresponding to the first message group via the graphical user interface comprises:
determining a to-be-displayed message from a plurality of session messages based on a grouping category of the first message group; and
displaying the to-be-displayed message based on a list style, and obtaining the instant message session list corresponding to the first message group.

7. The method according to claim 6, wherein the grouping category comprises at least one of: a time sequence group, an unread message group, a user-associated message group, and a processing progress group.

8. The method according to claim 7, wherein determining based on the grouping category of the first message group, the to-be-displayed message from the plurality of session messages comprises:
in response to the grouping category of the first message group being a time sequence group, determining a latest message from the plurality of session messages as the to-be-displayed message.

9. The method according to claim 7, wherein, in response to the grouping category of the first message group being a time sequence group, displaying the message within the instant message session list via the graphical user interface based on the view display style corresponding to the first message group comprises:
generating a scatter diagram, wherein a first coordinate axis of the scatter diagram represents a date, and a second coordinate axis of the scatter diagram represents a time point or a time period; and
displaying the message within the instant message session list as a coordinate point in the scatter diagram based on a receiving time of the message.

10. The method according to claim 7, wherein determining, based on the grouping category of the first message group, the to-be-displayed message from the plurality of session messages comprises:
in response to the group category of the first message group being an unread message group, determining, from the plurality of session messages, that a message that has not been read by a user as the to-be-displayed message.

11. The method according to claim 7, wherein in response to the group category of the first message group being an unread message group, displaying the message within the instant message session list via the graphical user interface based on the view display style corresponding to the first message group comprises:
sequentially displaying each unread message entry on the graphical user interface based on a receiving time of a corresponding unread message, wherein each unread message entry comprises an unread message and auxiliary information, and the unread message is highlighted in a corresponding unread message entry relative to the auxiliary information.

12. The method according to claim 7, wherein determining, based on the grouping category of the first message group, the to-be-displayed message from the plurality of session messages comprises:
in response to the grouping category of the first message group being the user-associated message group, determining, from the plurality of the session messages, that a message referring to a user is the to-be-displayed message.

13. The method according to claim 7, wherein in response to the grouping category of the first message group being the user-associated message group, displaying the message within the instant message session list via the graphical user interface based on the view display style corresponding to the first message group comprises:
displaying each user-associated message entry via the graphical user interface, wherein each user-associated message entry comprises a user-mentioned message and a reply control, and the reply control is configured to receive input content from a user.

14. The method according to claim 7, wherein determining, based on the grouping category of the first message group, the to-be-displayed message from the plurality of session messages comprises:
in response to the grouping category of the first message group being a processing progress group, determining, from the plurality of session messages, a latest message as to-be-displayed message.

15. The method according to claim 7, wherein in response to the grouping category of the first message group being the processing progress group, displaying the message within the instant message session list via the graphical user interface based on the view display style corresponding to the first message group comprises:
displaying a plurality of progress entries through the graphical user interface, wherein each of the plurality of progress entries is configured to display messages of different progress states, and each progress state comprises an unstarted state and an in-progress state;
determining a progress state of each message in the instant message session list; and
allocating each message within the instant message session list to a corresponding progress entry for display based on the progress state of each message in the instant message session list.

16. (canceled)

17. A system, comprising:
one or more memories collectively containing one or more programs; and
one or more processors, wherein the one or more processors are configured to, individually or collectively, perform an operation comprising:
displaying an instant message session list corresponding to a first message group via a graphical user interface, wherein the graphical user interface is provided by a terminal device;
in response to a switching operation of a message display style, determining a view display style corresponding to the first message group, wherein the view display style is different from a display style of the instant message session list; and
displaying a message within the instant message session list via the graphical user interface based on the view display style corresponding to the first message group.

18. One or more non-transitory computer-readable storage media containing, in any combination, computer program code that, when executable by a computer system, perform an operation comprising:
displaying an instant message session list corresponding to a first message group via a graphical user interface, wherein the graphical user interface is provided by a terminal device;
in response to a switching operation of a message display style, determining a view display style corresponding to the first message group, wherein the view display style is different from a display style of the instant message session list; and
displaying a message within the instant message session list via the graphical user interface based on the view display style corresponding to the first message group.

19. The system according to claim 17, wherein the graphical user interface comprises a style switching control element, and
determining the view display style corresponding to the first message group in response to the switching operation of the message display style comprises:
in response to a trigger operation on the style switching control element, determining the view display style corresponding to the first message group.

20. The system according to claim 17, wherein the operation further comprises:
displaying a plurality of group controls respectively corresponding to a plurality of message groups via the graphical user interface; and
in response to a selection operation on a first group control among the plurality of group controls, determining that a currently to-be-displayed group is the first message group.

21. The system according to claim 20, wherein, after displaying the message within the instant message session list via the graphical user interface based on the view display style corresponding to the first message group, the operation further comprises:
in response to a selection operation on a second group control among the plurality of group controls, determining that the currently to-be-displayed group is a second message group;
determining a view display style corresponding to the second message group; and
displaying the message within the instant message session list via the graphical user interface based on the view display style corresponding to the second message group.
